(19) United States
(12) Patent Application Publication
(10) Pub. No.: US 2015/0254731 A1
(43) Pub. Date: Sep. 10, 2015

(54) MULTI-MODAL, MULTI-SCENARIO ADVERTISING

(71) Applicant: Appsfire SAS, Paris (FR)

(72) Inventors: Ouriel Ohayon, Sunnyvale, CA (US); Yann Lechelle, Paris (FR)

(21) Appl. No.: 14/641,120

(22) Filed: Mar. 6, 2015

Related U.S. Application Data
(60) Provisional application No. 61/949,852, filed on Mar. 7, 2014.

(51) Int. Cl. G06Q 30/02; G06Q 30/06

(52) U.S. Cl. CPC G06Q 30/0276; G06Q 30/0269; G06Q 30/0272; G06Q 30/0277; G06Q 30/0641

(57) ABSTRACT

Methods, systems, and apparatus, including computer programs encoded on a computer storage medium, for performing by a client device, receiving from a remote system information comprising identifying data for a first application installed on the client device and contextual data describing a prior user interaction with the first application, obtaining an image of a user interface of a second application that is executing on the client device, creating an advertisement comprising a scaled-down version of the image adjacent to a presentation created from a template using the received information, presenting the advertisement such that the advertisement obscures the user interface of the second application, and in response to user interaction with the advertisement, launching the first application and causing a location in a user interface of the first application to be opened wherein the location is determined based on the contextual data.

### RELATED APPLICATION

This application claims the benefit of U.S. provisional patent Application No. 61/949,852, titled MULTI-MODAL, MULTI-SCENARIO NATIVE ADVERTISEMENT FORMATS WITH DYNAMIC CREATIVES DESCRIPTION, filed Mar. 7, 2014, which is incorporated herein by reference.

### BACKGROUND

This specification relates to advertising and, more particularly, displaying advertisement on client devices.

Display advertising delivers promotional messages to consumers by presenting visual advertisements (or “ads”) in web pages or in user interfaces of software applications. For example, a publisher of a web page can insert an ad space in the web page. When the web page is displayed by a web browser of a consumer's client device such as a mobile phone, the web browser can retrieve an ad of an advertiser from an ad server and display the ad in the ad space. As another example, a publisher's software application running on a consumer's client device can retrieve an ad of an advertiser from an ad server and display the ad within a user interface of the software application.

### SUMMARY

In general, one aspect of the subject matter described in this specification can be embodied in methods that include the actions of, performing by a client device, receiving from a remote system information comprising identifying data for a first application installed on the client device and contextual data describing a prior user interaction with the first application, obtaining an image of a user interface of a second application that is executing on the client device, creating an advertisement comprising a scaled-down version of the image adjacent to a presentation created from a template using the received information, presenting the advertisement such that the advertisement obscures the user interface of the second application, and in response to user interaction with the advertisement, launching the first application and causing a location in a user interface of the first application to be opened wherein the location is determined based on the contextual data. Other embodiments of this aspect include corresponding systems, apparatus, and computer programs.

These and other aspects can optionally include one or more of the following features. The identifying data for the first application can comprise a textual or graphical representation of the first application. The advertisement can comprise at least some of the contextual data describing the prior user interaction with the first application. Presenting the advertisement can comprise presenting a countdown timer in the user interface of the second application, and determining that the countdown time has expired and, in response thereto, presenting the advertisement. Presenting the advertisement can be in response to detecting user inactivity with the user interface of the second application. The contextual data can comprise one or more of: a geographic location, time, price, identification of merchandise associated with the prior user interaction, and a category of the merchandise. The template can comprise one or more fields for the contextual data, and an interactive icon for purchasing the merchandise. The interactive icon can be specific to the category of the merchandise. Obtaining the image of the user interface of the second application can comprise capturing a screenshot of a user interface of the second application.

Particular implementations of the subject matter described in this specification can be implemented to realize one or more of the following advantages. The system described herein receives from an ad server information comprising identifying data such as a name and icon for an advertiser application of an advertiser and contextual data describing a prior user interaction with the advertiser application. The system creates an advertisement promoting the advertiser application and presents the advertisement over another running application's user interface. The advertisement includes a scaled-down image of the other application's user interface, and a presentation created from a template using the identifying data and contextual data. By using the identifying data and contextual data with a template, it is not necessary for the advertiser to provide elaborate visual presentation (“creative”) to create an engaging advertisement. In response to user interaction with the advertisement, the system launches the advertiser application and causes a location in a user interface of the advertiser application to be opened wherein the location is determined based on the contextual data.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example system for displaying advertisements by a client device.

FIG. 2 is a flow chart illustrating example decision logic for displaying one or more ads for an advertiser application based on prior context.

FIG. 3 is a data flow diagram illustrating displaying of an ad for an already-installed target application using contextual data.

FIG. 4 illustrates a user interface of an example publisher application.

FIG. 5 illustrates an example advertisement for an advertiser application.

FIG. 6 illustrates an example countdown timer in a user interface of an example publisher application.

FIG. 7 illustrates an example user gesture to dismiss an advertisement.

FIG. 8 illustrates an example advertisement promoting an already-installed advertiser application using contextual data.

FIG. 9 illustrates another example advertisement promoting an already-installed advertiser application using contextual data.

FIG. 10 is a flowchart of an example method for displaying an advertisement of an advertiser application.

Like reference numbers and designations in the various drawings indicate like elements.

### DETAILED DESCRIPTION

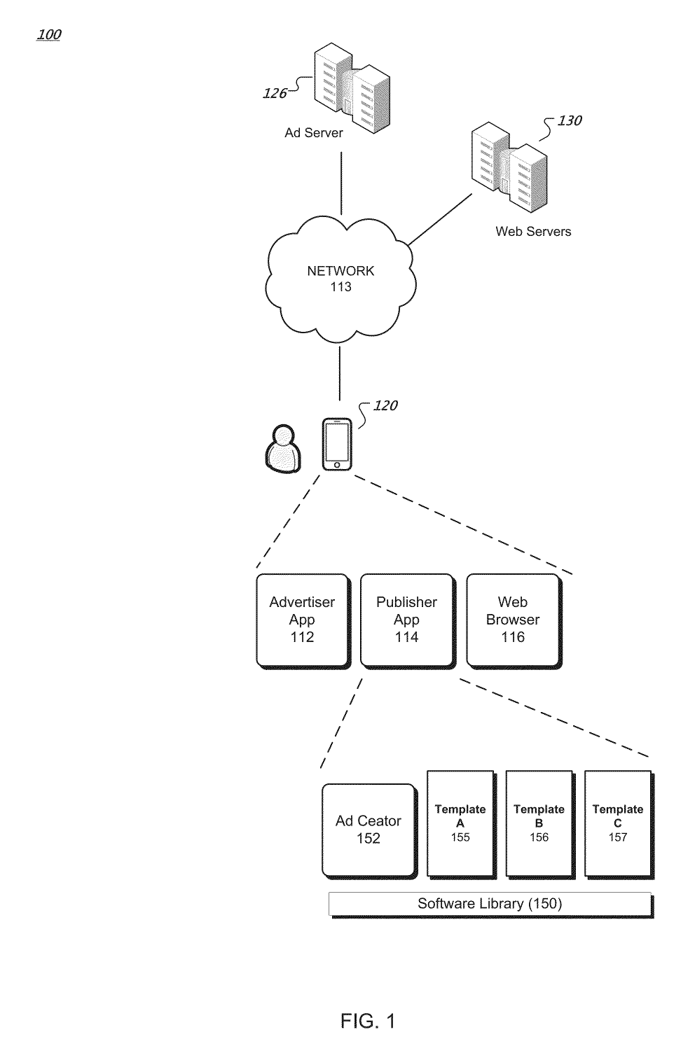

FIG. 1 illustrates an example system for displaying advertisements by a client device. In FIG. 1, an ad server 126 is a server system that serves ads for ad spaces on web pages and in software applications. The ad server 126 can also make decisions about what ads to be served, track transaction and other data on ads, for example. A user's client device 120 can communicate with the ad server 126 and web servers 130 through one or more communication networks 113 such as the Internet, for example. Here, the user's client device can be a mobile phone, a smart watch, a tablet computer, a personal computer, a game console, or an in-car media system. Other examples of a client device are possible.

The client device 120 comprises software components for providing various functionality of the client device 120. For instance, a web browser 116 is a software component that accesses the web servers 130 to retrieve a web page and displays the web page in a browser window of the web browser 116. The software components can include applications such as an email application, a calendar application, and messaging application. More particularly, the software components include a publisher application 114 from a publisher, and an advertiser application 112 from an advertiser, as will be further described below. The software components can comprise subcomponents that can execute on the same or on different processors of the client device 120.

The publisher application 114 is a software component that delivers one or more ads for the advertiser application 112 based on prior context. Here, prior context can be contextual data that describe a prior user interaction with the advertiser application 112 by the user of the client device 120. Contextual data can comprise one or more of: a geographic location, a time or time range, a date or date range, a price of a good or service, or identification of merchandise associated with the prior user interaction. For instance, if the advertiser application 112 is a hotel booking application, a prior user interaction can be that the user used the advertiser application 112 to search for a hotel room in Tokyo for a stay beginning on Mar. 4, 2014. The advertiser application 112 can forward to the ad server 126 (or another remote server) contextual data of the user interaction to the ad server 126 (or another server) for storage and analysis. In this example, the contextual data could comprise a geographical location (“Tokyo”), a time (“Mar. 4, 2014”), and an identification of merchandise (“hotel”). Other contextual data is possible. Alternatively, or in addition to the above, the advertiser application 112 can store the contextual data locally on the client device 120.

The publisher application 114 comprises a subcomponent ad creator 152 and one or more templates (e.g., template A 155, template B 156, and template C 157), for example. The ad creator 152 creates an advertisement for the advertiser application 112 by using one of the templates and, optionally, the prior contextual data. Generally speaking, a template specifies the graphical layout of an advertisement. By way of illustration, a template can include fields that can be populated by information for an advertised application (e.g., name, icon, screenshot, animation, video clip, price, promotional messages or graphics), and contextual data such as geographic location, time, or identification of merchandise as described earlier, for example. In some implementations, a template can includes an interactive icon to enable user interaction with the created advertisement. For instance, a user can select (e.g., tap on) an interactive icon to launch an application or navigate to another application. As another example, a user can select an interactive icon to dismiss the created advertisement. A template can also include one or more user input fields. When an advertisement based on the template is presented to a user, the user can enter additional information at the input fields. In an implementation, the ad creator 152 and the templates can be implemented in a software library 150 that is part of the publisher application 114. A template (and content populating the template) can be rendered by a user-interface software component of an operation system of the client device 120. For instance, a template can be rendered via UIKit framework for iOS operating system developed by Apple, Inc. of Cupertino, Calif.

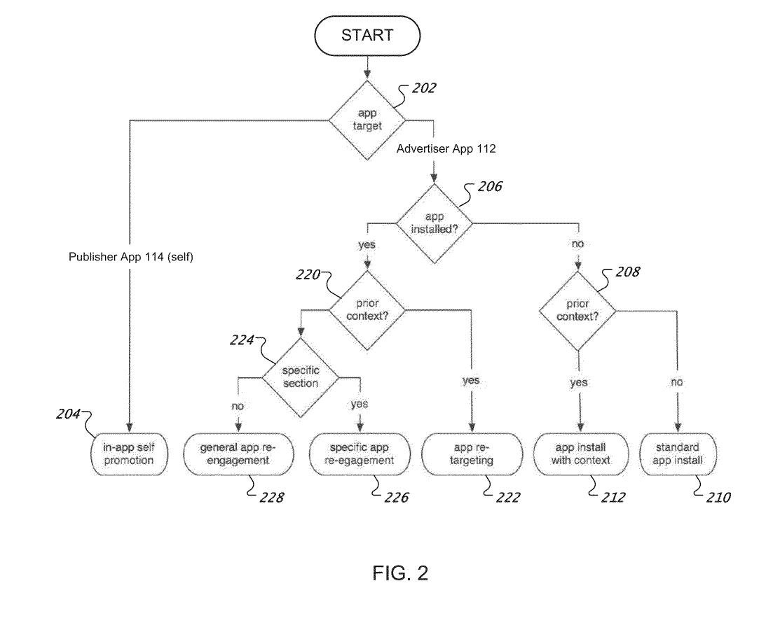

FIG. 2 is a flow chart illustrating example decision logic for displaying one or more ads for the advertiser application 112 based on contextual data. The decision logic can be implemented by the publisher application 114 (e.g., by the ad creator 152) or another software component of the client device 120. At the start, the publisher application 114 receives, from the ad server 126, identifying data (e.g., a unique text string) for a target application, and an advertising payload. The advertising payload can include a textual or graphical representation for the target application (e.g., a name, icon, screenshot, animation, or video clip), price, one or more promotional messages or graphics, or contextual data. The payload can be composed of structured data, for example, in JavaScript Object Notation (JSON) format.

In the following description, the “target application” refers to the application which will display the advertisement generated by the ad creator 152. The publisher application 114 first determines (based on the identifying data) whether the target application is the publisher application 114 itself, or another application such as, for example, the advertiser application 112 (step 202). If the publisher application 114 is the target application, the publisher application 114 delivers an in-application self-promotion in its user interface (step 204). For instance, the publisher application can display an ad promoting an additional feature or purchase (“in-application purchase”).

If the publisher application 112 is not the target application, the publisher application 114 determines whether the target application is currently installed on the client device 120 (step 206). If the target application is not currently installed on the client device 120, the publisher application 114 determines whether contextual data is available in the advertising payload (step 208), before proceeding to install the advertiser application 112. If contextual data is not available in the advertising payload, the publisher application 114 can present an advertisement promoting installation of the target application (step 210). If the user elects to install the target application (e.g., by interactively selecting an “install” button on the advertisement), the publisher application 114 causes the target application to be installed on the client device 120 (step 210). In some implementations, when the target application is launched by the user for the first time on the client device 120, the target application can be launched with a default start-up user interface (e.g., a tutorial on how to use the advertiser application 112). If contextual data is available in the advertising payload (step 208), when the target application is launched a location in a user interface of the target application will be opened. The location in the user interface of the target application is determined based on the contextual data (step 212). For instance, a particular location in the user interface of the target application (based on the contextual data) can be passed to the target application via arguments in a configuration file or a Uniform Resource Locator (URL) data structure (e.g., ad-app://hotel/[hotel_ID]/?loc=Tokyo,?t=030414) that the target application reads when being launched. By way of illustration, if the target application is a hotel booking application and the contextual data comprises the geographical location “Tokyo” and the time “Mar. 4, 2014”, the hotel booking application when opened will present a list of hotels in Tokyo that are available for booking on Mar. 4, 2014.

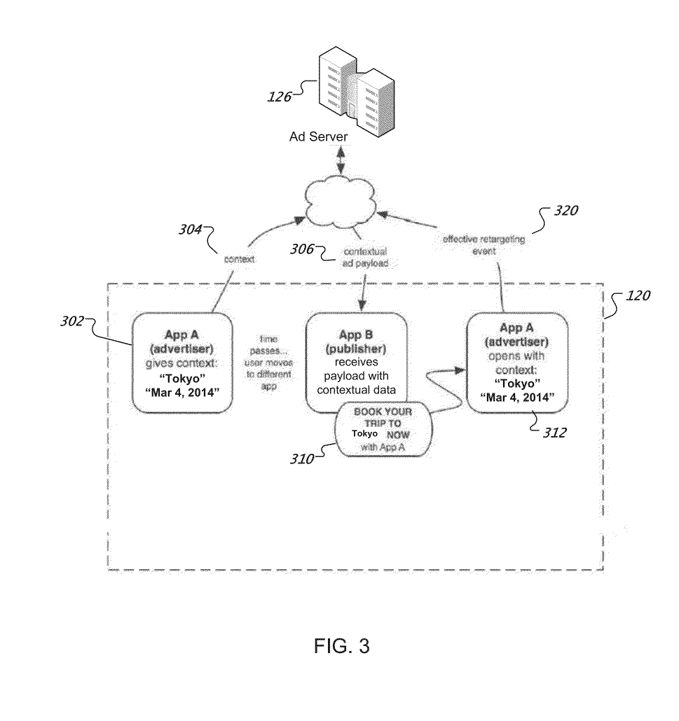

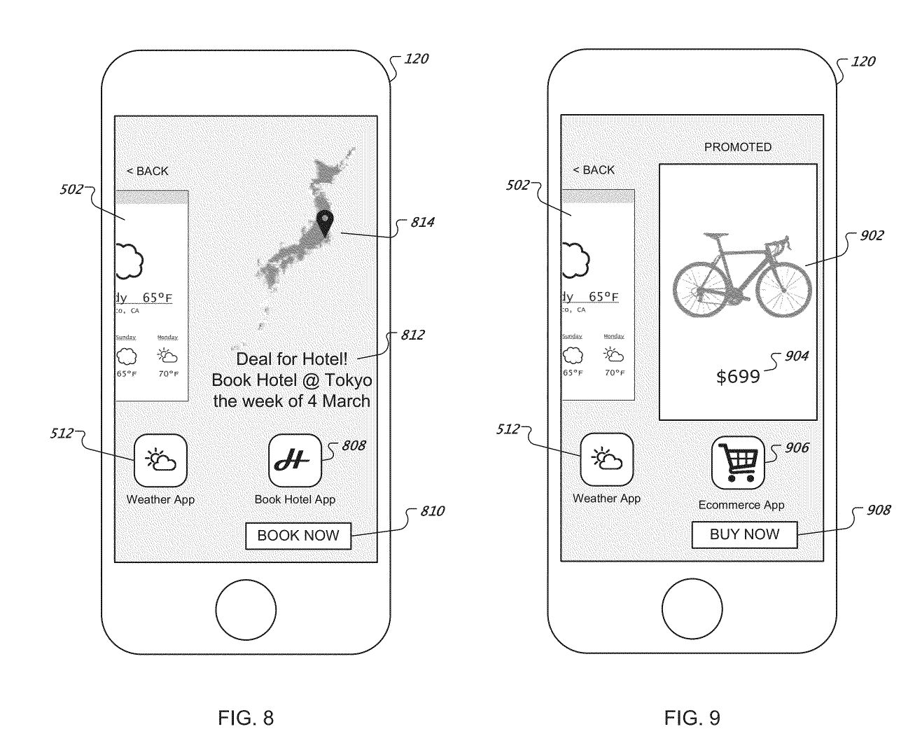

If the publisher application 112 determines that the target application is the advertiser application 112, and the advertiser application 112 is currently installed on the client device 120, the publisher application 112 determines whether contextual data is available in the advertising payload (step 220). If contextual data is available in the advertising payload, the publisher application 114 presents to the user an advertisement promoting the advertiser application 112 with the contextual data (step 222). An advertisement promoting an already-installed target application (the advertiser application 112) using contextual data will be further described below in reference to FIGS. 3 and 8.

If contextual data is not available in the advertising payload, the publisher application 114 determines whether a particular section of the user interface of the advertiser application 112 is specified, for example, in the advertising payload (step 224). For instance, if a hotel search section of the hotel booking application is specified, the hotel booking application is launched (e.g., by the user after seeing an advertisement of the hotel booking application) to a location in its user interface for searching hotels (step 226). If no particular section is specified, the hotel booking application is launched to a default start-up page (e.g., a tutorial, or a home page; step 228).

FIG. 3 is a data flow diagram illustrating displaying of an ad for an already-installed target application using contextual data. FIG. 3 encompasses the path from 202, 206, 220, to 222 in the decision diagram of FIG. 2. As described earlier with the example of the hotel booking application, the advertiser application 112 (the hotel booking application, or “App A” in FIG. 3) detects a user interaction in searching a hotel room in Tokyo starting on Mar. 4, 2014 (302), and provides the corresponding contextual data in a geographical location (“Tokyo”), time (“Mar. 4, 2014”), and identification of merchandise (“hotel”) to the ad server 126 (304).

The ad server 126 then sends identifying data of the hotel booking application and advertising payload with the contextual data to the publisher application 114 (“App B” in FIG. 3). Based on the identifying data and contextual data, the publisher application 114 presents an advertisement with the contextual data, promoting the advertiser application 112 (“App A”) (310).

The use can select an interactive icon in the advertisement, causing the client device 120 to launch the advertiser application 112 with the contextual data—e.g., starting the hotel booking application at a page searching for a hotel room in Tokyo starting Mar. 4, 2014 (312). For instance, after detecting the user's selection of the interactive icon, the publisher application 114 can send a notification to an operating system of the client device 120, causing the operating system to launch the hotel booking application. The instruction for launching at a page searching for a hotel room in Tokyo starting Mar. 4, 2014 can be passed to the hotel booking application using arguments in a configuration file or a URL data structure. Additionally, the advertiser application 112 (or another software running on the client device 120) can send a confirmation of the launch event (an effective retargeting event) to the ad server 126 (320). The ad server 126 can record this transaction information so the publisher of the publishing application 114 can charge the advertiser of the advertiser application 112 for the launch event, for example.

In some implementations, the contextual data can be provided to the ad server 126 by another application (e.g., a browser cookie from another party). The ad server 126 can hold an auction for an advertisement to be displayed by the publisher application 112 (“App B” in FIG. 3) based on the contextual data and selects among advertisers based on respective bid prices or other targeting criteria.

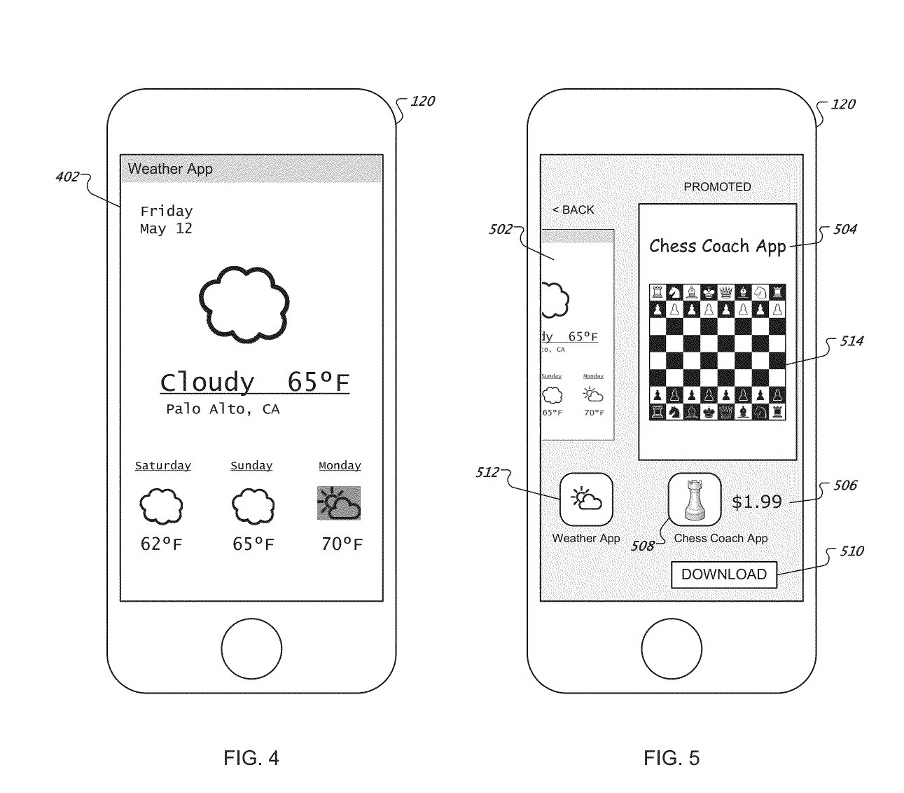

FIGS. 4-7 illustrate user interface examples in displaying an advertisement for a target application.

FIG. 4 illustrates a user interface of an example publisher application. In the example of FIG. 4, a weather application (the publisher application 114) displays in its user interface 402 current weather condition and 3-day forecast of Palo Alto, Calif.

As described with the path 202, 206, 208, to 210 in the decision diagram of FIG. 2, the publisher application 114 may receive from the ad server 126 identifying data for an advertiser application (e.g., a chess coach application) and an advertising payload. The advertising payload in this example includes an application title, an icon, a price, and a screenshot for the advertiser application. The publisher application 114 determines that the advertiser application is not yet installed on the client device 120, and creates an advertisement to promote the advertiser application.

The ad creator 152 (or another software component of the publisher application 114) can create an advertisement for the advertiser application by first obtaining an image of a user interface of the publisher application 114. For instance, the ad creator 152 can capture a screenshot of the current user interface of the publisher application 114. As another example, the image can be a (canned) sample user interface (of the publisher application 114) stored in a memory (e.g., flash memory) of the client device 120.

The ad creator 152 then creates an advertisement comprising a scaled-down version of the image (e.g., a scaled-down screenshot of the publisher application 114) adjacent to a presentation promoting the advertiser application. For instance, the image can be scaled down to approximately a half size (in linear dimensions) of the user interface 402 to provide enough space for the presentation promoting the advertiser application. The presentation can be placed next to one or more sides or corners of the scaled-down image. For instance, the presentation can be placed next to the right side of the scaled-down image. As another example, the presentation can be placed in areas surrounding the scaled-down image. In one implementation, the image is not scaled down while the presentation is placed on top of the image and covers at least a portion of the image. The ad creator 152 can create the advertisement to adapt to different device screen sizes and resolutions, and to different device orientations (e.g., landscape, or portrait orientation).

The presentation of the advertisement is created from a template (e.g., template A 155 stored in a memory of the client device 120), using the information received form the ad server 126. For instance, the publisher application can fill in fields (e.g., name, price, icon, screenshot) in the template with corresponding information in the advertising payload received from the ad server 126. The template also includes an interactive icon. In one implementation, the presentation is created by the ad server 126 and provided to the publisher application 114.

FIG. 5 illustrates an example advertisement for the advertiser application “chess coach application.” As illustrated in FIG. 5, the advertisement includes a scaled-down screenshot of the weather application (502), name of the advertiser application (504), price of the advertiser application (506), icon of the advertiser application (508), screenshot of the advertiser application (514), and an interactive icon 510 (“DOWNLOAD”). The advertisement also includes an icon for the publisher application (512). The user can select the interactive icon 510, causing the client device 120 to download and install the chess coach application. When a video (or animation) of the advertiser application is presented in the advertisement (e.g., in place of the screenshot 514), the user can tap on the video (or a play/pause icon) to play or pause the video. Here, the advertisement is presented over (i.e., obscuring) the publisher application's user interface. The publisher application does not need to be suspended, and can continue running on the client device 120.

The publisher application 114 can present the advertisement illustrated in FIG. 5 when the publisher application 114 detects user inactivity with the user interface of the publisher application 114 (e.g., no user interaction with the user interface 402 for 30 seconds).

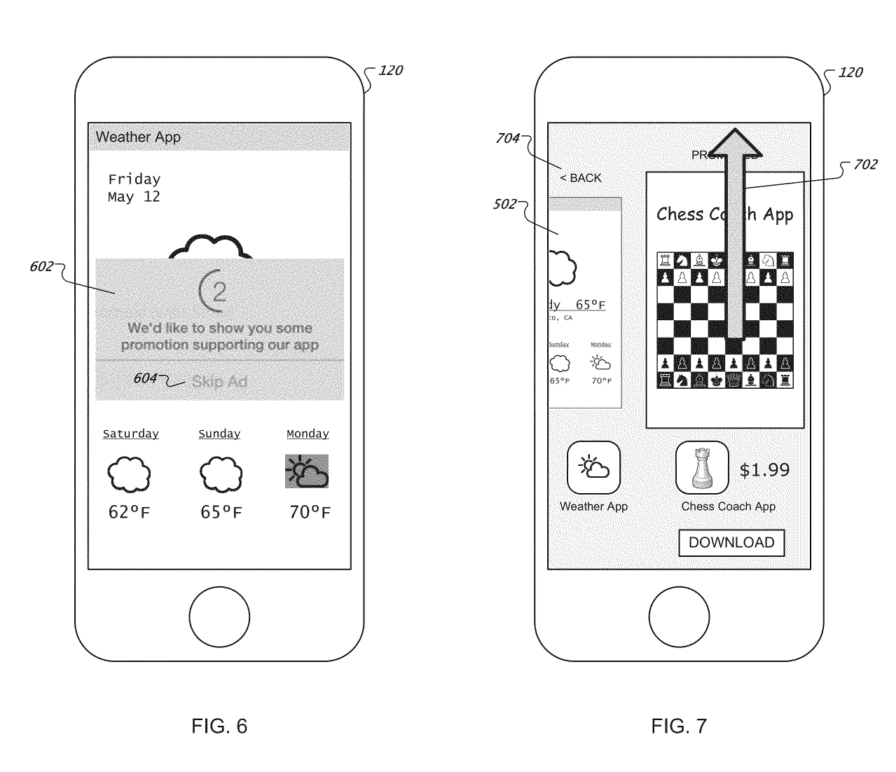

In some implementations, the publisher application 114 presents the advertisement by first presenting in its user interface a countdown timer (602 illustrated in FIG. 6). The publisher application 114 then presents the advertisement after determining the countdown timer has expired. The user of the client device 120 can prevent the advertisement being displayed by dismissing the countdown timer 602 (e.g., selecting a “Skip Ad” icon 604).

In other implementations, the publisher application 114 presents the advertisement during a user “break out” session of the publisher application 114. A user break out session of the publisher application 114 can be a time period between two different features or a temporary stop within the publisher application 114. For instance, a game application can present an advertisement promoting another application between play stages of the game application.

When the advertisement is presented, the user can dismiss the advertisement by using a swiping up gesture on a representation of the advertiser application, as illustrated by the arrow 704 in FIG. 7. The user can also dismiss the advertisement by selecting a selectable icon (“<BACK” 704 in FIG. 7), or by selecting (tapping on) the scaled-down image of the publisher application's user interface 502. The client device 120 resumes displaying the publisher application's user interface (e.g., 402 illustrated in FIG. 4), after the user's dismissal of the advertisement, for example. In one implementation, the user can dismiss the advertisement by using a swiping down gesture on the presentation of the advertiser application. In this case, the publisher application 114 can present the advertisement again at a later time to remind the user about the advertiser application. In another implementation, the user can use a swipe-right or swipe-left gesture on the presentation of the advertiser application to “rotate” to another ad presentation (for the same or a different advertiser application).

FIG. 8 illustrates an example advertisement promoting an already-installed advertiser application using contextual data. As described earlier with the hotel booking application in reference to FIG. 3, the publisher application 114 (e.g., the weather application) can create (and present) an advertisement promoting the hotel booking application with contextual data in a geographical location (“Tokyo”), time (“Mar. 4, 2014”), and identification of merchandise (“hotel”). As illustrated in FIG. 8, the advertisement includes a presentation (e.g., based on a template) of the hotel booking application's icon (808), an interactive icon “BOOK NOW” (810), a promotional message based on the contextual data “Deal for Hotel! Book Hotel @ Tokyo the week of 4 March” (812), and a graphic (814) based on the contextual data (a map of Japan with a location icon for Tokyo). In an implementation, the graphics 814 can be created by the publisher application 114 by accessing a map application on the client device 120 for a map tile based on the geographical location (e.g., a city name, or a pair of GPS coordinates) in the contextual data. The promotional message 812 can be provided by the advertiser or the ad server 126 (as part of the advertising payload), or can be generated by the publisher application 114 by filling a pre-configured promotional message in the template with the contextual data (“Tokyo” and “Mar. 4, 2014”). In an implementation, the promotional message 812 or the graphics 814 are provided by the advertiser or the ad server 126 (as part of the advertising payload) wherein the promotional message 812 or the graphics 814 can be based on the contextual data. The advertisement also includes a scaled-down image of the publisher application's user interface (502) and an icon for the publisher application (512). The use can select the interactive icon 810, causing the client device 120 to launch the hotel booking application with the contextual data—e.g., starting the hotel booking application at a page searching for a hotel room in Tokyo starting Mar. 4, 2014, as previously described in reference to step 312 in FIG. 3. In one implementation, the advertisement can also include a user input field, for example, for the user to enter another date or another city in the advertisement. When the user select the interactive icon 801 (“BOOK NOW”), the hotel booking application is launched at a page searching for a hotel room for the date or city entered by the user.

FIG. 9 illustrates another example advertisement promoting an already-installed advertiser application using contextual data. In this example, the contextual data describes that the user previously searched for a bicycle using an e-commerce application installed on the client device 120. An advertisement promoting the e-commerce application includes a scaled-down image of the publisher application's user interface (502) and an icon for the publisher application (512). The advertisement also includes presentation of the e-commerce application based on the contextual and identifying data, including an image of a bicycle (902), a price for the bicycle (904), an icon for the e-commerce application (906), and an interactive icon “BUY NOW” (908). The user can select the interactive icon “BUY NOW” (908), causing the client device 120 to launch the e-commerce application with the contextual data—e.g., starting the e-commerce application at a shopping page for the bicycle advertised in FIG. 9.

In some implementations, contextual data provided by the ad server 126 also includes a category for the merchandise associated with the prior user interaction. For instance, a category for the hotel booking application example illustrated in FIGS. 3 and 8 can be “travel.” As another example, a category for the e-commerce application example illustrated in FIG. 9 can be “shopping.” When creating an advertisement promoting an advertiser application using a template, the ad creator 152 can fill the template with an interactive icon specific to the category. For instance, the advertisement illustrated in FIG. 8 has the interactive icon “BOOK NOW” (810) for booking a hotel. The advertisement illustrated in FIG. 9 has the interactive icon “BUY NOW” (908) for buying a bicycle. In this way, the advertisement can dynamically adapt to the merchandise (and its category) and showcase a most engaging activity for the user.

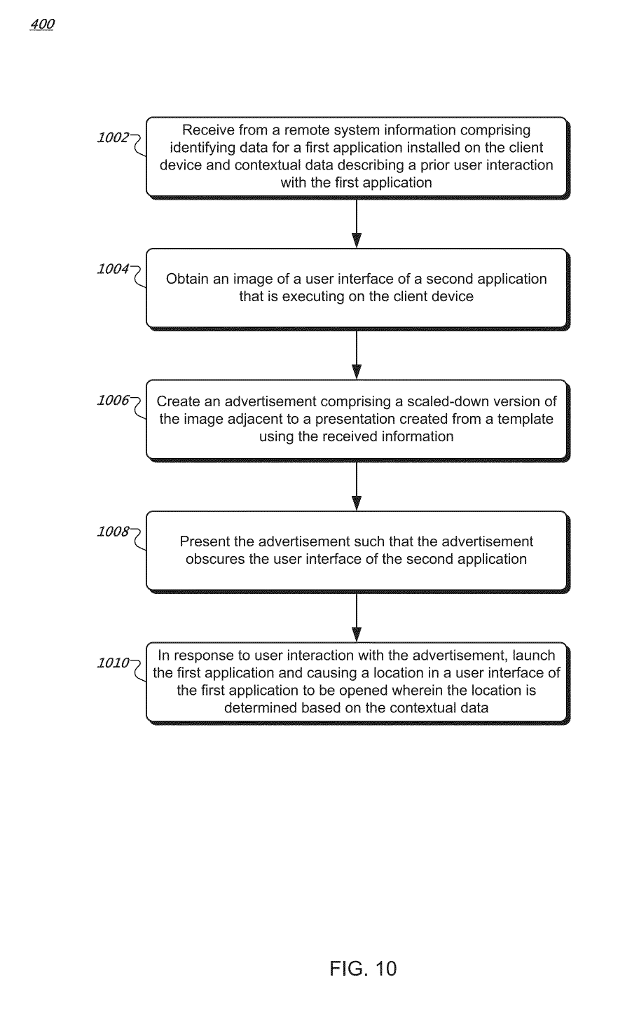

FIG. 10 is a flowchart of an example method for displaying an advertisement of an advertiser application. The method can be implemented by one or more software components executing on one or more processors of the client device 120, for example. The method begins by, receiving from a remote system information comprising identifying data for a first application installed on the client device and contextual data describing a prior user interaction with the first application (1002). The method obtains an image of a user interface of a second application that is executing on the client device (1004). The method creates an advertisement comprising a scaled-down version of the image adjacent to a presentation created from a template using the received information (1006). The method presents the advertisement such that the advertisement obscures the user interface of the second application (1008). In response to user interaction with the advertisement, the method launches the first application and causing a location in a user interface of the first application to be opened wherein the location is determined based on the contextual data (1010).

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
performing by a client device:
receiving from a remote system information comprising identifying data for a first application installed on the client device and contextual data describing a prior user interaction with the first application;
obtaining an image of a user interface of a second application that is executing on the client device;
creating an advertisement comprising a scaled-down version of the image adjacent to a presentation created from a template using the received information;
presenting the advertisement such that the advertisement obscures the user interface of the second application; and
in response to user interaction with the advertisement, launching the first application and causing a location in a user interface of the first application to be opened wherein the location is determined based on the contextual data.

2. The method of claim 1, wherein the identifying data for the first application comprises a textual or graphical representation of the first application.

3. The method of claim 1, wherein the advertisement comprises at least some of the contextual data describing the prior user interaction with the first application.

4. The method of claim 1, wherein presenting the advertisement comprises:
presenting a countdown timer in the user interface of the second application; and
determining that the countdown time has expired and, in response thereto, presenting the advertisement.

5. The method of claim 1, wherein presenting the advertisement is in response to detecting user inactivity with the user interface of the second application.

6. The method of claim 1, wherein the contextual data comprises one or more of: a geographic location, time, price, identification of merchandise associated with the prior user interaction, and a category of the merchandise.

7. The method of claim 6, wherein the template comprises one or more fields for the contextual data and an interactive icon for purchasing the merchandise.

8. The method of claim 7, wherein the interactive icon is specific to the category of the merchandise.

9. The method of claim 1, wherein obtaining the image of the user interface of the second application comprises capturing a screenshot of a user interface of the second application.

10. A system comprising:
one or more computers programmed to perform operations comprising:
receiving from a remote system information comprising identifying data for a first application installed on a client device and contextual data describing a prior user interaction with the first application;
obtaining an image of a user interface of a second application that is executing on the client device;
creating an advertisement comprising a scaled-down version of the image adjacent to a presentation created from a template using the received information;
presenting the advertisement such that the advertisement obscures the user interface of the second application; and
in response to user interaction with the advertisement, launching the first application and causing a location in a user interface of the first application to be opened wherein the location is determined based on the contextual data.

11. The system of claim 10, wherein the identifying data for the first application comprises a textual or graphical representation of the first application.

12. The system of claim 10, wherein the advertisement comprises at least some of the contextual data describing the prior user interaction with the first application.

13. The system of claim 10, wherein presenting the advertisement comprises:
presenting a countdown timer in the user interface of the second application; and
determining that the countdown time has expired and, in response thereto, presenting the advertisement.

14. The system of claim 10, wherein presenting the advertisement is in response to detecting user inactivity with the user interface of the second application.

15. The system of claim 10, wherein the contextual data comprises one or more of: a geographic location, time, price, identification of merchandise associated with the prior user interaction, and a category of the merchandise.

16. The system of claim 15, wherein the template comprises one or more fields for the contextual data and an interactive icon for purchasing the merchandise.

17. The system of claim 16, wherein the interactive icon is specific to the category of the merchandise.

18. The system of claim 10, wherein obtaining the image of the user interface of the second application comprises capturing a screenshot of a user interface of the second application.

19. A storage device having instructions stored thereon that when executed by one or more computers perform operations comprising:
receiving from a remote system information comprising identifying data for a first application installed on a client device and contextual data describing a prior user interaction with the first application;
obtaining an image of a user interface of a second application that is executing on the client device;
creating an advertisement comprising a scaled-down version of the image adjacent to a presentation created from a template using the received information;
presenting the advertisement such that the advertisement obscures the user interface of the second application; and
in response to user interaction with the advertisement, launching the first application and causing a location in a user interface of the first application to be opened wherein the location is determined based on the contextual data.

20. The storage device of claim 19, wherein the identifying data for the first application comprises a textual or graphical representation of the first application.

21. The storage device of claim 19, wherein the advertisement comprises at least some of the contextual data describing the prior user interaction with the first application.

22. The storage device of claim 19, wherein presenting the advertisement comprises:
presenting a countdown timer in the user interface of the second application; and
determining that the countdown time has expired and, in response thereto, presenting the advertisement.

23. The storage device of claim 19, wherein presenting the advertisement is in response to detecting user inactivity with the user interface of the second application.

24. The storage device of claim 19, wherein the contextual data comprises one or more of: a geographic location, time, price, identification of merchandise associated with the prior user interaction, and a category of the merchandise.

25. The storage device of claim 24, wherein the template comprises one or more fields for the contextual data and an interactive icon for purchasing the merchandise.

26. The storage device of claim 25, wherein the interactive icon is specific to the category of the merchandise.

27. The storage device of claim 19, wherein obtaining the image of the user interface of the second application comprises capturing a screenshot of a user interface of the second application.
